(19) United States
(12) Patent Application Publication
(10) Pub. No.: US 2009/0037360 A1
(43) Pub. Date: Feb. 5, 2009

(54) Auto-Triggered Incremental Execution of Object Business Rules in Database Applications

(75) Inventor: Boris MELAMED, Jerusalem (IL)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/832,399

(22) Filed: Aug. 1, 2007

(51) Int. Cl. G06F 17/00

(52) U.S. Cl. 706/47

(57) ABSTRACT

A method for applying business rules to data stored in a table of a database. The method includes creating a plurality of maps wherein each map comprises a list of business rules that are triggered by a change of data stored in the table of the database. In one aspect, responsive to a given business rule being modified, an old version of the modified business rule is removed from the plurality of maps, and a new version of the modified business rule is re-registered within the plurality of maps, the new version of the modified rule is then automatically applied to data stored in the table of the database.

### FIELD OF THE INVENTION

The present invention relates generally to data processing, and more particularly to techniques for executing object-oriented business rules (referred to herein as “object business rules”).

### BACKGROUND OF THE INVENTION

A business rule is an operating principle or policy that software must satisfy. Organizations typically have their own set of business rules that must be reflected in the software the organization develops. For example, a business rule might state that no credit check is to be performed on return customers. Other business rules could define a tenant in terms of solvency or list preferred suppliers and supply schedules. Accordingly, business rules are used to help an organization achieve goals, communicate among principals and agents, communicate between the organization and interested third parties, demonstrate fulfillment of legal obligations, operate more efficiently, automate operations, perform analysis on current practices, and so on. A business rule is typically cohesive—i.e., describes only one concept (e.g., focuses on only one issue). By ensuring that business rules are cohesive, business rules are generally easier to define and are likely to be reused within various software algorithms.

With respect to implementation of business rules in software, although object business rules—i.e., business rules written in accordance with an object-oriented paradigm—can be translated into data integrity constraints (in terms of a relational model of database management), execution of object business rules and evaluation of constraints, however, presents challenges in database application environments. For example, in database applications, business rules are typically invoked by manually setting database triggers and where the business rules are specified relative to an OO (UML) model, there is typically a disconnect between the OO layer and the DB schema layer, where UML model elements need to be translated to DB schema elements while specifying the trigger. Also, correct propagation of triggered business rule execution is dependent on all involved triggers being set up correctly. Further, it is non-trivial for a user (e.g., an engineer) to create all necessary triggers for a business rule such that the data remains consistent, and the user has to consider all possible cases where data is affected including, for example, a change of impacting attribute values, the creation/deletion of an instance that indirectly affects data, or modification/removal of the business rule itself.

### BRIEF SUMMARY OF THE INVENTION

In general, this specification describes a method for applying business rules to data stored in a table of a database. The business rules specifying conditions that must always be true or must always be false. The method includes creating a plurality of maps wherein each map comprises a list of business rules that are triggered by a change of data stored in the table of the database, including creating a first map including a list of business rules in which the data is in a pulling path of the business rules, a second map including a list of business rules in which the data is in a pushing path of the business rules, and a third map including a list of business rules in which the data is in both a pulling path and a pushing path of the business rules. Data is in a pulling path of a given business rule if the data is dependent upon an evaluated result of the given business rule, and data is in a pushing path of a given business rule if the data has impact on data in pulling paths of the business rule. In one aspect, responsive to a given business rule being modified, an old version of the modified business rule is removed from the plurality of maps, and a new version of the modified business rule is re-registered within the plurality of maps.

Implementations may provide one or more of the following advantages. A data processing system is disclosed that can execute business rules and evaluate constraints incrementally, in a way that is scalable with database applications.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram of a data processing system for processing business rules in accordance with one implementation.

FIG. 2 illustrates one implementation of an algorithm that is executable by the data processing system of FIG. 1 when an object transaction is about to be committed.

FIG. 3 illustrates one implementation of an algorithm that is executable by the data processing system of FIG. 1 responsive to a business rule being removed.

FIG. 4 illustrates one implementation of an algorithm that is executable by the data processing system of FIG. 1 responsive to a business rule being modified.

FIG. 5 illustrates one implementation of an algorithm that is executable by the data processing system of FIG. 1 responsive to a business rule being created.

FIG. 6 illustrates one implementation of an algorithm that is executable by the data processing system of FIG. 1 responsive to a value being set, changed or removed.

FIG. 7 illustrates one implementation of an algorithm that is executable by the data processing system of FIG. 1 responsive to a constraint being removed.

FIG. 8 illustrates one implementation of an algorithm that is executable by the data processing system of FIG. 1 responsive to a constraint being modified.

FIG. 9 illustrates one implementation of an algorithm that is executable by the data processing system of FIG. 1 responsive to a constraint being created.

FIG. 10 is a block diagram of a data processing system suitable for storing and/or executing program code in accordance with one implementation of the invention.

Like reference symbols in the various drawings indicate like elements.

### DETAILED DESCRIPTION OF THE INVENTION

The present invention relates generally to data processing, and more particularly to techniques for executing object business rules. The following description is presented to enable one of ordinary skill in the art to make and use the invention and is provided in the context of a patent application and its requirements. The present invention is not intended to be limited to the implementations shown but is to be accorded the widest scope consistent with the principles and features described herein.

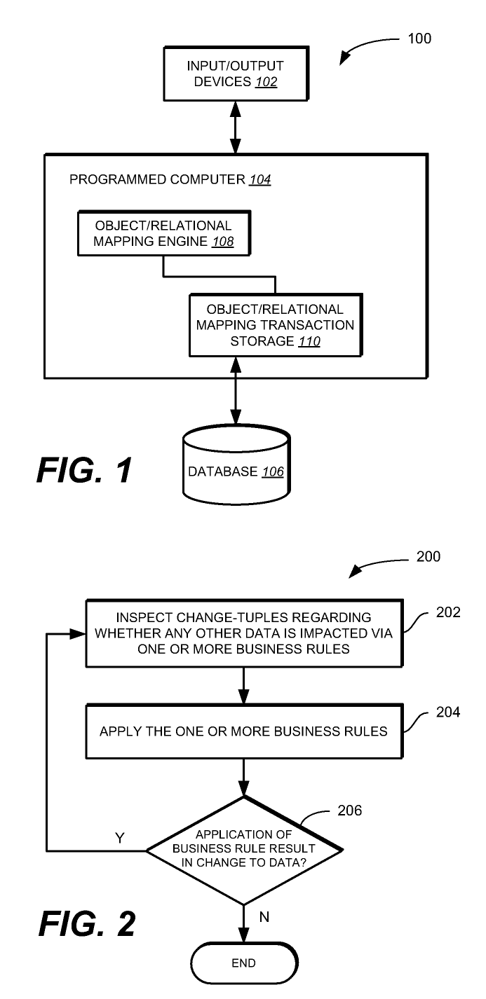

FIG. 1 illustrates a data processing system 100 in accordance with one implementation of the invention. The data processing system 100 includes input and output devices 102, a programmed computer 104, and a database 106. The input and output devices 102 can include devices such as a printer, a keyboard, a mouse, a digitizing pen, a display, a printer, and the like. The programmed computer 104 can be any type of computer system, including for example, a workstation, a desktop computer, a laptop computer, a personal digital assistant (PDA), a cell phone, a network, and so on. Running on the programmed computer 104 is an object/relational mapping layer engine (ORM) that maps the object model (e.g., UML model elements) to a relational database (e.g., DB schema elements). In one implementation, the programmed computer 104 further includes an object/relational mapping transaction storage 110 in which all object changes are kept in a list until a given transaction is committed to the database 106. In one implementation, business rules (converted into independent objects) are expressed over an application object model as, for example, MOF's (Meta-Object Facility) QVT (Queries, Views and Transformations). Various operations of the data processing system 100 will now be described.

Extracting Triggering/Propagation Logic from Business Rules and Constraints

The techniques discussed herein are generally applicable to all types of business rules. Table 1 below provides several example types of business rule.

TABLE 1

| Business | |
|---|---|
| Rule Type | Definition |
| Inclusion | In class Person, parents includes mother and father. |
| | Moreover, grandparents includes parents.parents. |
| Conversion | In class Person, fullName = firstName + “ ” + |
| Formula | lastName. |
| Lookup Tables | In class State, a translation table stateName <-> |
| | abbreviation. |
| Equivalence | In class Person, firstName == givenName |

These business rules above can be used to populate (derive) missing values from existing values. In addition, the business rules can also be viewed as constraints for validating data consistency and reporting of clashes. Table 2 below provides additional constraint types that can be used for validation.

TABLE 2

| Constraint Type | Definition |
|---|---|
| Enumeration | In class Person, gender is one of (male, female). |
| Uniqueness | In class Person, socialSecurityNumber is a unique |
| | attribute. |

All of the above rules/constraints have the following in common. 1) The parameters (arguments, variables) of a rule are (in EMF (E-Modeling Framework) terminology) EReferences, EAttributes or paths such as customers.address.zip. Each path of a given rule is rooted in the same class, as set forth in the examples above. In one implementation, each rule/constraint path consists of zero or one or more references and zero or one attribute. 2) A given business rule has at least one path that is “pulling”—i.e., the values pointed to by such a path depend on the evaluated result of this rule. In the above examples, pulling paths are: (a) Person.parents; (a′) Person.grandparents; (b) Person.fullName; (c) both State.stateName and abbreviation; (d) both Person.firstName and givenName. 3) A given business rule has at least one path that is “pushing”—i.e., the values pointed to by such a path impact values of “pulling” paths of that rule. In the above examples, pushing paths are: (a) Person.mother, father; (a′) Person.parents.parents; (b) Person.firstName, lastName; (c) both State.stateName and abbreviation; (d) both Person.firstName and givenName. As is clear from (c) and (d), a path can be both pulling and pushing. In one implementation, with respect to detecting which rule/constraint to trigger when a data change occurs, the essential aspect is the inspection of whether the attribute/reference of a changed/added/deleted value is contained in pushing/pulling paths of business rules and constraints (as discussed in greater detail below).

In one implementation, whenever the data processing system 100 starts, the following in-memory hash maps are constructed. The in-memory hash maps are used for fast look-up of business rules that are affected by a given value change. In one implementation, the in-memory hash maps are also updated whenever a business rule is added, deleted or changed. 1. Map: reference or attribute->List of rules where this reference or attribute is part of one of the pulling paths. 2. Map: reference or attribute->

List of rules where this reference or attribute is part of one of the pushing paths. 3. Map: reference or attribute->List of rules where this reference or attribute is part of any path. These in-memory hash maps are used for detecting when to trigger execution of business rules and evaluation of constraints. In another implementation, in lieu of in-memory hash maps, the business rules can be maintained in one big list (within a fast memory). In such an implementation, when a value changes, every business rule in the list is examined whether the changed value's attribute/reference is in one of the pushing paths of the rule.

### Triggering and Propagating Execution of Rules in the Event of Changes to Data

FIG. 2 illustrates an algorithm 200 that is executable by a data processing system (e.g., data processing system 100) when an object transaction is about to be committed. Change-tuples are inspected regarding whether the change-tuples impact any other data via business rules (step 202). In one implementation, the following terminology applies—Item: tuple [Object, Reference or Attribute, Values]; Pointer: tuple [Object, Reference or Attribute]. The involved business rules are applied (step 204). A determination is made whether application of a given business rule results in new changes to data (step 206). If application of a given business rule results in new changes to data, the algorithm 200 returns to step 202. If application of a given business rule does not result in new changes to data, the algorithm 200 ends.

Since every change event holds the retired or created Item tuple, in one implementation, the tuple's reference or attribute is used for looking up the triggered business rules as follows—for all retired values, trigger all rules that “pull”—i.e., those that can populate the empty reference or attribute value, and for all retired, changed or added values, trigger all rules that “push”—i.e., use these values to populate other references or attributes. In general, querying for affected/impacted values from database is a slow operation. Therefore, requested “pointers” to values that are not already in fast memory are gathered and batch queries are executed so that as few queries as possible are executed for loading those values.

### Triggering and Propagating Execution of Rules in the Event of Rule Modification

In one implementation, additional infrastructure is needed in order for the data processing system 100 to automatically trigger and propagate execution of business rules in the event of a modification to a business rule. With the usual static DB schema, where for example each concrete class is mapped to a DB table, the following separate class/table for keeping track of which value was populated by which business rule can be utilized:
Class “ResponsibleRules” with:
   owningObject:Object
   refOrAttrID:String
   setByRuleID:String [indexed]
      With a dynamic (untyped) database schema, typically with just two tables, OBJECTS and VALUES, the following can be implemented:
A column “SET_BY_RULE_ID” in table VALUES [indexed]

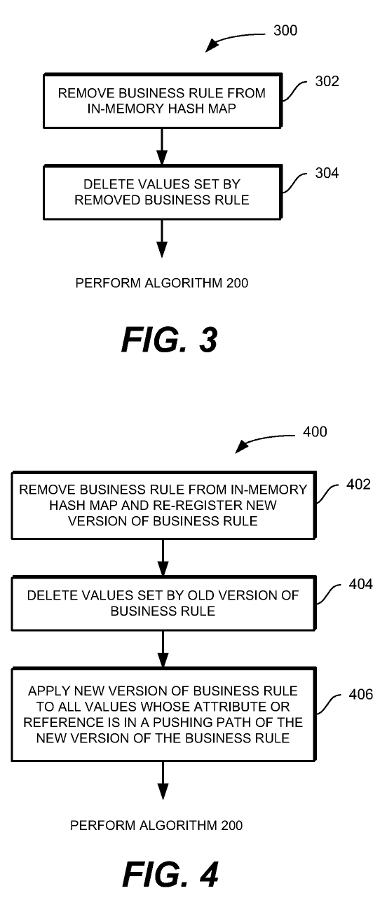

FIG. 3 illustrates one implementation of an algorithm 300 that can be performed by the data processing system 100 responsive to a business rule being removed from the data processing system 100. The business rule is removed from an in-memory hash map (step 302). All values that were set by the removed business rule are deleted (e.g., from the database 106) (step 304). After step 304, the algorithm 200 is performed to trigger other business rules that have pulling paths containing references or attributes of deleted values, and to further trigger other business rules impacted by these changes, iteratively.

FIG. 4 illustrates one implementation of an algorithm 400 that can be performed by the data processing system 100 responsive to a business rule being modified within the data processing system 100. The business rule is removed from a corresponding in-memory hash map and a new version of the business rule is re-registered within the in-memory hash map (step 402). All values that were set by the old business rule are deleted (e.g., from the database 106) (step 404). The new version of the business rule is applied to all values whose attribute or reference is in a pushing path of the business rule (step 406). After step 406, the algorithm 200 is performed to trigger other business rules that have pulling paths containing references or attributes of deleted values, and to further trigger other business rules impacted by these changes, iteratively.

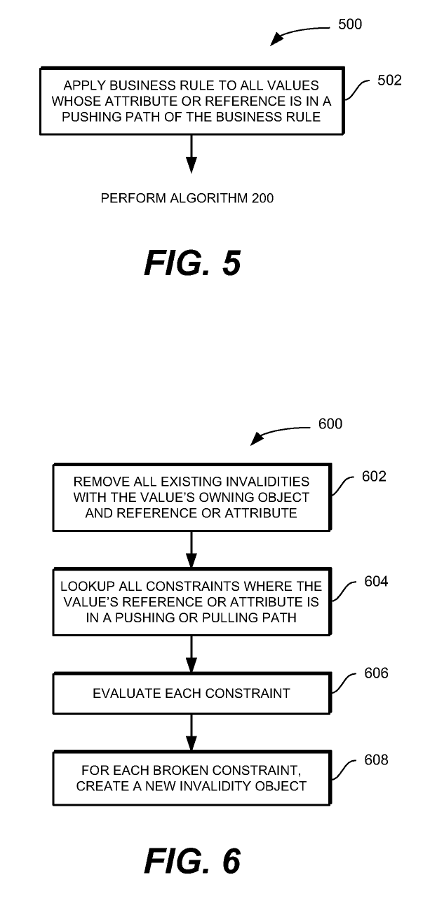

FIG. 5 illustrates one implementation of an algorithm 500 that can be performed by the data processing system 100 responsive to a business rule being created within the data processing system 100. The business rule is applied to all values whose attribute or reference is in a pushing path of the business rule (step 502). After step 502, the algorithm 200 is performed to trigger other business rules that have pulling paths containing this value's reference or attribute.

### Triggering Evaluation of Constraints

In one implementation, additional infrastructure is needed to in order for the data processing system 100 to automatically trigger evaluation of constraints. Note: All business rules are also constraints. For example, integrity constraints can be used to enforce business rules on data within tables of the database 106. In one implementation, business rules specify conditions and relationships that must always be true, or must always be false. Because each company defines its own policies about things like salaries, employee numbers, inventory tracking, and so on, a different set of rules can be specified for each database table—i.e., when an integrity constraint applies to a table, all data in the table must conform to the corresponding rule. In one implementation, the following separate class/table for keeping track of which value conflicts with which constraint can be utilized by the data processing system 100.
Class “Invalidity” with:
   owningObject:Object
   refOrAttrID:String
   brokenConstraintID:String [invalidities]
      In one implementation, this class is necessary for providing a quick access to information about data quality.

FIG. 6 illustrates one implementation of an algorithm 600 that can be performed by the data processing system 100 responsive to a value being set, changed or removed. All existing Invalidities with this value's owning object and reference or attribute is removed (step 602). All constraints where this value's reference or attribute is in one of the (pushing or pulling) paths are looked up (step 604). Each constraint is evaluated (step 606). For each broken constraint, a new “Invalidity” object is created (step 608).

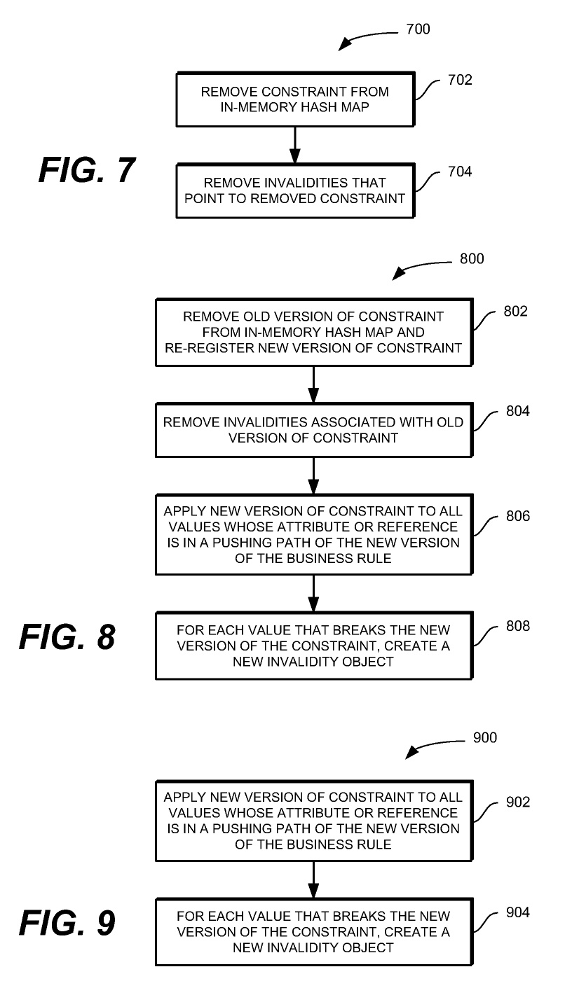

FIG. 7 illustrates one implementation of an algorithm 700 that can be performed by the data processing system 100 responsive to a constraint being removed. The constraint is removed from an in-memory hash map (step 702). All invalidities that point to the deleted constraint are removed (e.g., from the database 106) (step 704).

FIG. 8 illustrates one implementation of an algorithm 800 that can be performed by the data processing system 100 responsive to a constraint being modified. The old version of the constraint is removed from an in-memory hash map and a new version of the constraint is re-registered within the in-memory hash map (step 802). All invalidities associated with the old version of the constraint are removed (step 804). The new version of the constraint with all values whose attribute or reference is in one of the (pushing or pulling) paths of the constraint is evaluated (step 806). For each value that breaks the new version of the constraint, a new “Invalidity” object is created (step 808).

FIG. 9 illustrates one implementation of an algorithm 900 that can be performed by the data processing system 100 responsive to a constraint being created. The new constraint with all values whose attribute or reference is in one of the (pushing or pulling) paths of the constraint is evaluated (step 902). For each value that breaks the new constraint, a new “Invalidity” object is created (step 904).

With respect to execution of batch queries (as discussed above), querying for affected/impacted values from database is a slow operation. Therefore, in one implementation, requested “pointers” to values that are not already in fast memory are gathered and batch queries are executed so that as few queries as possible are executed for loading those values. (Note that evaluation of a unique constraint differs from that of other constraint types. It always requires a query that involves all objects with the given reference or attribute.)

One or more of method (or algorithm) steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In one implementation, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

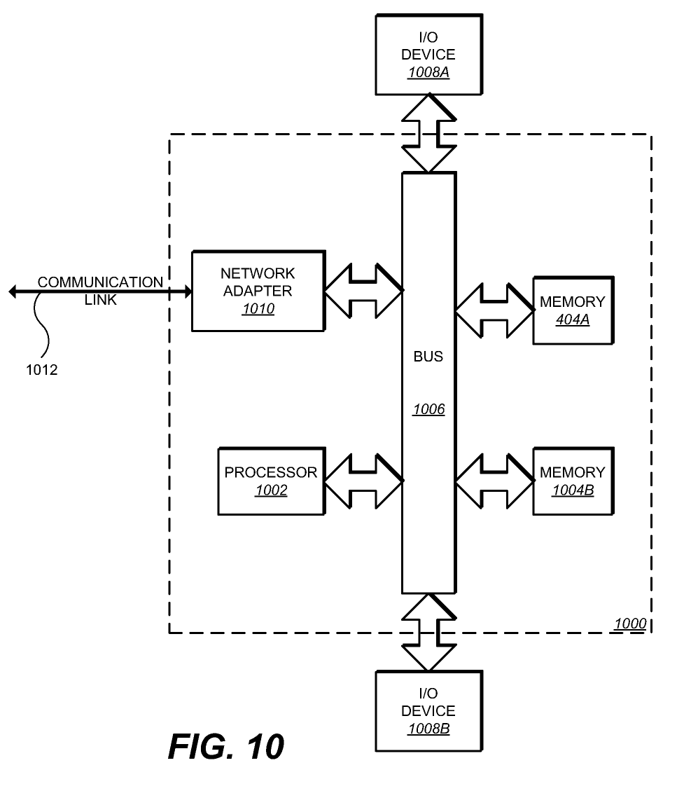

FIG. 10 illustrates a data processing system 1000 suitable for storing and/or executing program code. Data processing system 1000 includes a processor 1002 coupled to memory elements 1004A-B through a system bus 606. In other implementations, data processing system 1000 may include more than one processor and each processor may be coupled directly or indirectly to one or more memory elements through a system bus. Memory elements 1004A-B can include local memory employed during actual execution of the program code, bulk storage, and cache memories that provide temporary storage of at least some program code in order to reduce the number of times the code must be retrieved from bulk storage during execution. As shown, input/output or I/O devices 1008A-B (including, but not limited to, keyboards, displays, pointing devices, etc.) are coupled to data processing system 1000. I/O devices 1008A-B may be coupled to data processing system 1000 directly or indirectly through intervening I/O controllers (not shown).

In one implementation, a network adapter 1010 is coupled to data processing system 1000 to enable data processing system 1000 to become coupled to other data processing systems or remote printers or storage devices through communication link 1012. Communication link 1012 can be a private or public network. Modems, cable modems, and Ethernet cards are just a few of the currently available types of network adapters.

Various implementations for executing object-oriented business rules have been described. Nevertheless, various modifications may be made to the implementations. For example, steps of the methods described above can be performed in a different order and still achieve desirable results. Accordingly, many modifications may be made without departing from the scope of the following claims.

What is claimed is:

1. A method for applying business rules to data stored in a table of a database, the business rules specifying conditions that must always be true or must always be false, the method comprising:
creating a plurality of maps wherein each map comprises a list of business rules that are triggered by a change of data stored in the table of the database, including creating a first map including a list of business rules in which the data is in a pulling path of the business rules, a second map including a list of business rules in which the data is in a pushing path of the business rules, and a third map including a list of business rules in which the data is in both a pulling path and a pushing path of the business rules, wherein data is in a pulling path of a given business rule if the data is dependent upon an evaluated result of the given business rule, and data is in a pushing path of a given business rule if the data has impact on data in pulling paths of the business rule;
responsive to receiving a change in the data stored in the table of the database,
determining one or more business rules that are affected by the data change; and
automatically applying the one or more affected business rules to the data stored in the database until there are no more changes to the data stored in the database;
responsive to a given business rule being deleted,
removing the deleted business rule from the plurality of maps and delete all data from the table that was previously set by the deleted business rule;
responsive to a given business rule being modified,
removing an old version of the modified business rule from the plurality of maps and re-registering a new version of the modified business rule within the plurality of maps; and
deleting all data from the table that was previously set by the old version of the business rule, and applying the new version of the modified business rule to the data that is a pushing path of the new version of the business rule; and
responsive to a given business rule being created,
applying the created business rule to the data that is a pushing path of the created business rule.

2. The method of claim 1, wherein the following class is utilized by a data processing system to keep track of which value of data within the table was populated by a given business rule:
Class “ResponsibleRules” with:
owningObject:Object
refOrAttrID:String
setByRuleID:String [indexed]

3. A computer program product comprising a computer-readable medium, the computer-readable medium being encoded with a computer program for applying business rules to data stored in a table of a database, the business rules specifying conditions that must always be true or must always be false, wherein the computer program, when executed on a computer, causes the computer to:
create a plurality of maps wherein each map comprises a list of business rules that are triggered by a change of data stored in the table of the database, including creating a first map including a list of business rules in which the data is in a pulling path of the business rules, a second map including a list of business rules in which the data is in a pushing path of the business rules, and a third map including a list of business rules in which the data is in both a pulling path and a pushing path of the business rules, wherein data is in a pulling path of a given business rule if the data is dependent upon an evaluated result of the given business rule, and data is in a pushing path of a given business rule if the data has impact on data in pulling paths of the business rule;
responsive to receiving a change in the data stored in the table of the database,
determine one or more business rules that are affected by the data change; and
automatically apply the one or more affected business rules to the data stored in the database until there are no more changes to the data stored in the database;
responsive to a given business rule being deleted,
remove the deleted business rule from the plurality of maps and deleted all data from the table that was previously set by the deleted business rule;
responsive to a given business rule being modified,
remove an old version of the modified business rule from the plurality of maps and re-register a new version of the modified business rule within the plurality of maps; and
delete all data from the table that was previously set by the old version of the business rule, and apply the new version of the modified business rule to the data that is a pushing path of the new version of the business rule; and
responsive to a given business rule being created,
apply the created business rule to the data that is a pushing path of the created business rule.
